(19) United States
(12) Patent Application Publication
(10) Pub. No.: US 2024/0242157 A1
(43) Pub. Date: Jul. 18, 2024

(54) Water Conservancy Project Operation Trend Prediction Method

(71) Applicant: Changjiang Spatial Information Technology Engineering Co., Ltd. (Wuhan), Wuhan (CN)

(72) Inventors: Shuangping Li, Wuhan (CN); Zuqiang Liu, Wuhan (CN); Bin Zhang, Wuhan (CN); Min Zheng, Wuhan (CN); Yuanzhu Chen, Wuhan (CN); Weiyan Cheng, Wuhan (CN); Bo Shi, Wuhan (CN); Yonghua Li, Wuhan (CN); Zhao Tang, Wuhan (CN); Huawei Wang, Wuhan (CN)

(21) Appl. No.: 18/619,141

(22) Filed: Mar. 27, 2024

(30) Foreign Application Priority Data
Mar. 31, 2023 (CN) 202310335148.X

(51) Int. Cl. G06Q 10/0637; G06Q 50/06

(52) U.S. Cl. CPC G06Q 10/06375; G06Q 50/06

(57) ABSTRACT

This application provides a water conservancy project operation trend prediction method. The method includes: acquiring to-be-processed initial monitoring data, and determining a first type of monitoring data and a second type of monitoring data according to the initial monitoring data; determining a target nonlinear fitting model from a preset nonlinear fitting model set according to the second type of monitoring data; and predicting the state of a target water conservancy project by a new model constructed by combining the target nonlinear fitting model with the models in the preset prediction model set.

### CROSS-REFERENCE TO RELATED APPLICATION

The present application claims the benefit of Chinese patent application Ser. No. 20/231,0335148.X filed on Mar. 31, 2023, the entire contents of which is hereby incorporated by reference.

### FIELD OF TECHNOLOGY

This application relates to the field of computer technology, in particular to a water conservancy project operation trend prediction method. One or more embodiments of this description also relate to a water conservancy project operation trend prediction apparatus, a computing device, and a computer-readable storage medium.

### BACKGROUND

Water conservancy project is a strategic infrastructure to ensure water safety, and is responsible for flood control, irrigation, power generation, water supply, navigation and other tasks. As the eyes and ears of the operation state of reservoir water conservancy project, water conservancy project safety monitoring can find abnormal situations in time and take corresponding treatment measures through technical means such as instrument monitoring and patrol inspection, which is an important guarantee for the safe operation of the project. Establishing an accurate and effective analysis model of deformation behavior of water conservancy projects is an important means to evaluate the operation safety of water conservancy projects.

The analysis, processing and prediction model of deformation monitoring data are of great significance to the safety monitoring of water conservancy projects. At present, single models such as nonlinear model, time series model, gray model and neural network model are usually adopted to process, analyze and predict the monitoring data of water conservancy projects. Different calculation methods have different advantages and have certain applications in practical projects, but these methods also have certain limitations. There is an urgent need for a better solution.

### SUMMARY

In view of this, this application provides a water conservancy project operation trend prediction method. One or more embodiments of this description also relate to a water conservancy project operation trend prediction apparatus, a computing device, and a computer-readable storage medium to solve the technical deficiencies existing in the prior art.

According to a first aspect of embodiments of this description, there is provided a water conservancy project operation trend prediction method, including:
acquiring to-be-processed initial monitoring data, and performing gross error test on the initial monitoring data to determine first monitoring data;
performing data test on the first monitoring data based on a preset data test algorithm to determine second monitoring data, wherein the preset data test algorithm includes a standard deviation test, a mean value test, a contrast method, a correlation analysis method or an envelope method; and
interpolating the second monitoring data, and filtering and preprocessing the interpolated monitoring data to obtain target monitoring data.

According to a second aspect of the embodiments of this description, there is provided a water conservancy project operation trend prediction apparatus, including:
a data acquisition module, configured to acquire to-be-processed initial monitoring data, and perform gross error test on the initial monitoring data to determine first monitoring data;
a data test module, configured to perform data test on the first monitoring data based on a preset data test algorithm to determine second monitoring data, wherein the preset data test algorithm includes a standard deviation test, a mean value test, a contrast method, a correlation analysis method or an envelope method; and
a data processing module, configured to interpolate the second monitoring data, and filter and preprocess the interpolated monitoring data to obtain target monitoring data.

According to a third aspect of embodiments of this description, there is provided a computing device, including:
a memory and a processor; wherein
the memory is configured to store computer-executable instructions, and the processor is configured to implement the steps of the water conservancy project operation trend prediction method when executing the computer-executable instructions.

According to a fourth aspect of embodiments of this description, there is provided a computer-readable storage medium storing computer-executable instructions which, when executed by a processor, implement the steps of any one of the water conservancy project operation trend prediction methods.

Embodiments of this description provide a water conservancy project operation trend prediction method and apparatus, wherein the water conservancy project operation trend prediction method includes: acquiring to-be-processed initial monitoring data, and determining a first type of monitoring data and a second type of monitoring data according to the initial monitoring data; determining a target nonlinear fitting model from a preset nonlinear fitting model set according to the second type of monitoring data, wherein the preset nonlinear fitting model set includes at least one of a logarithmic function, an exponential function, a power function and a polynomial function; and predicting the state of a target water conservancy project based on the first type of monitoring data and according to the target nonlinear fitting model and a preset prediction model set, wherein prediction models in the preset prediction model set are trained based on the second type of monitoring data. Therefore, the new model is constructed by combining the target nonlinear fitting model with the models in the preset prediction model set, and the state of the target water conservancy project is predicted, so that the prediction accuracy is improved.

### BRIEF DESCRIPTION OF DRAWINGS

FIG. 1 is an overall system architecture diagram of a water conservancy project operation trend prediction method according to an embodiment of this description;

FIG. 2 is a flowchart of a water conservancy project operation trend prediction method according to an embodiment of this description;

FIG. 3 is an overall functional flow diagram of a water conservancy project operation trend prediction method according to an embodiment of this description;

FIG. 4 is a structural schematic diagram of a water conservancy project operation trend prediction apparatus according to an embodiment of this description; and

FIG. 5 is a structural block diagram of a computing device according to an embodiment of this description.

### DETAILED DESCRIPTION

Numerous specific details are set forth in the following description in order to provide a thorough understanding of this description. However, this description can be implemented in many other ways different from those described herein, and those skilled in the art can make similar promotion without violating the connotation of this description, so this description is not limited by the specific embodiments disclosed below.

The terminology used in one or more embodiments of this description is for the purpose of describing specific embodiments only and is not intended to limit one or more embodiments of this description. The singular forms “a”, “the” and “said” used in one or more embodiments of this description and the appended claims are also intended to include the plural forms, unless the context clearly indicates other meaning. It should also be understood that the term “and/or” used in one or more embodiments of this description refers to and includes any or all possible combinations of one or more associated listed items.

It should be understood that although the terms such as first and second may be used to describe various information in one or more embodiments of this description, this information should not be limited to these terms. These terms are only used to distinguish the same type of information from one another. For example, without departing from the scope of one or more embodiments of this description, the first may also be called the second, and similarly, the second may also be called the first. Depending on the context, the word “if” as used herein may be interpreted as “during” or “when” or “in response to determining”.

The existing mathematical models have the following characteristics when predicting the safety trend of water conservancy projects: (1) Nonlinear models have different limitations due to model types. For example, although some models can solve practical problems such as small sample, nonlinear and high-dimensional pattern recognition, the selection of kernel functions is very important for different sample data and will affect the prediction accuracy. (2) The gray model accumulates the original data sequence to reduce the randomness of the data sequence, but the disadvantage is that the gray model is not applicable to the case that the original data grows non-exponentially. (3) Time series models often need a large number of sample data as the calculation basis. For a short data sequence, due to less information and weak regularity, there are often problems such as insufficient accuracy and low stability. (4) The BP neural network model adopts a gradient descent learning method, which makes the learning process easily fall into the local extreme point of the network, resulting in the unstable prediction effect of the model.

Based on this, it is necessary to develop a high-precision, stable and intelligent method for constructing a combined model for water conservancy project operation trend prediction. The purpose of the water conservancy project operation trend prediction method according to embodiments of the present disclosure is to construct an accurate and effective model for analyzing, evaluating and predicting deformation behaviors of water conservancy projects, to improve the accuracy and intelligence of deformation prediction for water conservancy projects.

In this description, a water conservancy project operation trend prediction method is provided, and this description simultaneously relates to a water conservancy project operation trend prediction apparatus, a computing device, and a computer-readable storage medium, which will be elaborated one by one in the following embodiments.

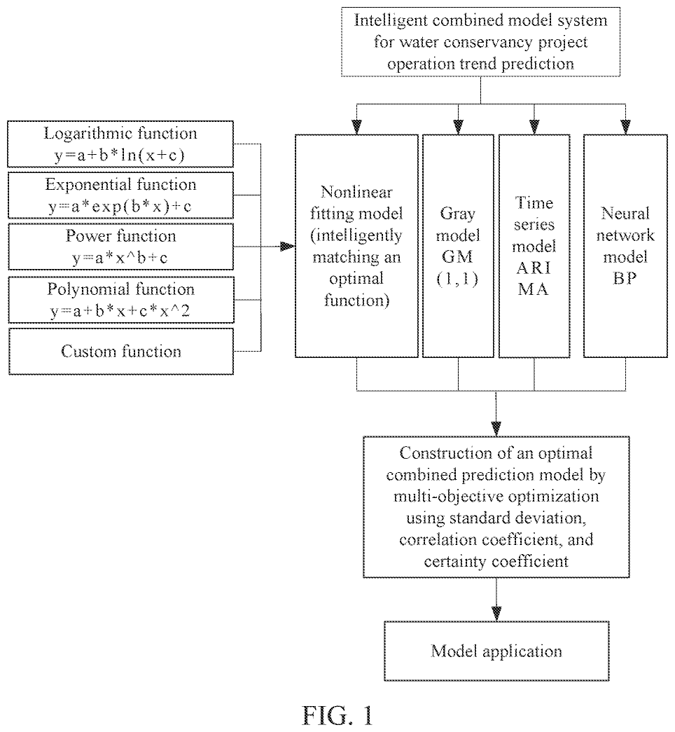

FIG. 1 shows an overall system architecture diagram of a water conservancy project operation trend prediction method according to an embodiment of this description.

Specifically, a system for the water conservancy project operation trend prediction method may be an intelligent combined model system for water conservancy project operation trend prediction, which includes a nonlinear fitting model, a gray model, a time series model, and a neural network model. The nonlinear fitting model is obtained by intelligently matching an optimal function, wherein intelligently matching an optimal function here is to select a nonlinear function from a logarithmic function, an exponential function, a power function, a polynomial function and a custom function as the nonlinear fitting model.

According to the embodiments of this description, the new model is constructed by combining the target nonlinear fitting model with the models in the preset prediction model set, and the state of the target water conservancy project is predicted, so that the prediction accuracy is improved.

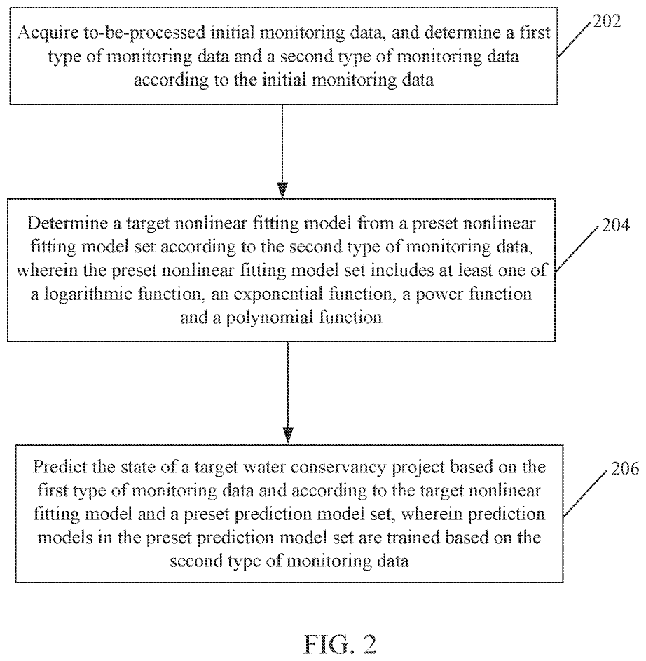

FIG. 2 shows a flowchart of a water conservancy project operation trend prediction method according to an embodiment of this description, and the water conservancy project operation trend prediction method specifically includes the following steps.

Step 202: acquiring to-be-processed initial monitoring data, and determining a first type of monitoring data and a second type of monitoring data according to the initial monitoring data.

In a possible implementation, the step of determining a first type of monitoring data and a second type of monitoring data according to the initial monitoring data includes: periodically detecting the initial monitoring data to determine periodic data and aperiodic data; periodically decomposing the periodic data to determine periodic item data and trend item data; and determining the first type of monitoring data according to the periodic item data, and determining the second type of monitoring data according to the aperiodic data and the trend item data. The initial monitoring data may be data of a monitoring data effect size sequence, the first type of monitoring data may be data of a periodic item data sequence, and the second type of a monitoring data may be data of trend item data sequence.

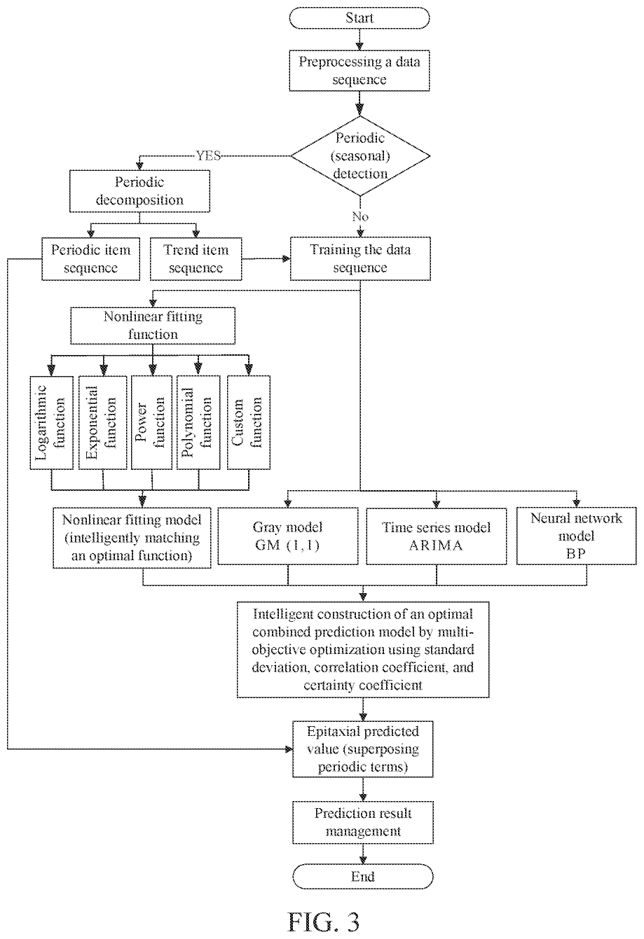

In practical application, referring to FIG. 3, generally, the monitoring data effect size sequence consists of periodic terms and trend terms, and can be decomposed into a periodic term data sequence and a trend term data sequence by a traditional method. Generally, using the trend item data to construct prediction models can achieve better results.

Step 204: determining a target nonlinear fitting model from a preset nonlinear fitting model set according to the second type of monitoring data, wherein the preset nonlinear fitting model set includes at least one of a logarithmic function, an exponential function, a power function and a polynomial function.

In a possible implementation, the step of determining a target nonlinear fitting model from a preset nonlinear fitting model set according to the second type of monitoring data includes: determining the target nonlinear fitting model from a preset nonlinear fitting model set according to the second type of monitoring data and through a target coefficient index. Specifically, when an intelligent combined model for water conservancy project operation trend prediction is constructed, firstly, an optimal nonlinear fitting model needs to be selected, that is, a preset logarithmic function, exponential function, power function, polynomial function or custom function is fitted according to the form of a single effect size sequence, and one nonlinear function is selected as a nonlinear fitting model using indexes such as a standard deviation, a correlation coefficient and a certainty coefficient.

According to the embodiments of this description, the optimal nonlinear fitting model for single effect size fitting is intelligently matched, and the intelligent combined model system for water conservancy project operation trend prediction is intelligently constructed by performing multi-objective optimization on the optimal nonlinear fitting model, the single-factor gray model, the time series model and the neural network model, which improves the accuracy of water conservancy project operation trend prediction and plays an important role for monitoring data in water conservancy project operation trend analysis.

Step 206: predicting the state of a target water conservancy project based on the first type of monitoring data and according to the target nonlinear fitting model and a preset prediction model set, wherein prediction models in the preset prediction model set are trained based on the second type of monitoring data.

In a possible implementation, the step of predicting the state of a target water conservancy project based on the first type of monitoring data and according to the target nonlinear fitting model and a preset prediction model set includes: determining a target prediction model according to the target nonlinear fitting model and a preset prediction model set and through a target coefficient index; and predicting the state of a target water conservancy project based on the first type of monitoring data and the target prediction model. Specifically, referring to FIG. 3, a combined model is intelligently constructed for epitaxial prediction of effect size by performing multi-objective optimization on the models such as the selected nonlinear fitting model, the gray model GM (1,1), the time series model ARIMA, and the neural network model BP using indexes such as standard deviation, correlation coefficient, and certainty coefficient.

In a possible implementation, the step of predicting the state of a target water conservancy project based on the first type of monitoring data and the target prediction model includes:

determining a state calculated value based on the first type of monitoring data and the target prediction model; and determining the state of the target water conservancy project according to the state calculated value and a state threshold. Referring to FIG. 3, after the construction of the combined model is completed, by the intelligent combined model system epitaxial prediction value, i.e., the value calculated by superposing effect size periodic terms, the epitaxial prediction of water conservancy project operation trends is truly realized. By comparison analysis with a previously set threshold, the safe operation state of water conservancy projects can be predicted.

Embodiments of this description provide a water conservancy project operation trend prediction method and apparatus, wherein the water conservancy project operation trend prediction method includes: acquiring to-be-processed initial monitoring data, and determining a first type of monitoring data and a second type of monitoring data according to the initial monitoring data;

determining a target nonlinear fitting model from a preset nonlinear fitting model set according to the second type of monitoring data, wherein the preset nonlinear fitting model set includes at least one of a logarithmic function, an exponential function, a power function and a polynomial function; and predicting the state of a target water conservancy project based on the first type of monitoring data and according to the target nonlinear fitting model and a preset prediction model set, wherein prediction models in the preset prediction model set are trained based on the second type of monitoring data. Therefore, the new model is constructed by combining the target nonlinear fitting model with the models in the preset prediction model set, and the state of the target water conservancy project is predicted, so that the prediction accuracy is improved.

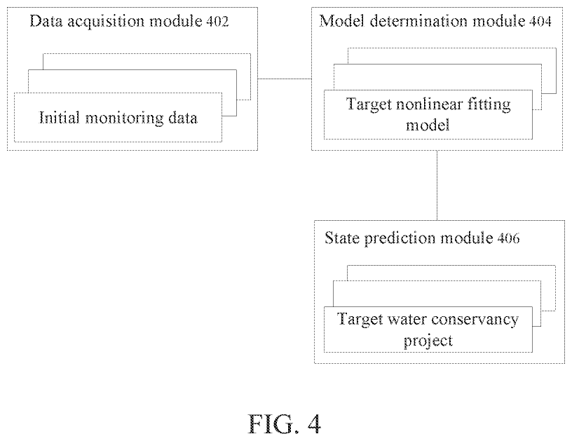

Corresponding to the method embodiment described above, this description also provides an embodiment of a water conservancy project operation trend prediction apparatus, and FIG. 4 shows a structural schematic diagram of a water conservancy project operation trend prediction apparatus according to one embodiment of this description. As shown in FIG. 4, the apparatus includes:
a data acquisition module 402, configured to acquire to-be-processed initial monitoring data, and determine a first type of monitoring data and a second type of monitoring data according to the initial monitoring data;
a model determination module 404, configured to determine a target nonlinear fitting model from a preset nonlinear fitting model set according to the second type of monitoring data, wherein the preset nonlinear fitting model set includes at least one of a logarithmic function, an exponential function, a power function and a polynomial function; and
a state prediction module 406, configured to predict the state of a target water conservancy project based on the first type of monitoring data and according to the target nonlinear fitting model and a preset prediction model set, wherein prediction models in the preset prediction model set are trained based on the second type of monitoring data.

Optionally, the data acquisition module 402 is further configured to:
periodically detect the initial monitoring data to determine periodic data and aperiodic data;
periodically decompose the periodic data to determine periodic item data and trend item data; and
determine the first type of monitoring data according to the periodic item data, and determine the second type of monitoring data according to the aperiodic data and the trend item data.

Optionally, the model determination module 404 is further configured to:
determine the target nonlinear fitting model from a preset nonlinear fitting model set according to the second type of monitoring data and through a target coefficient index.

Optionally, the state prediction module 406 is further configured to:
determine a target prediction model according to the target nonlinear fitting model and a preset prediction model set and through a target coefficient index; and
predict the state of a target water conservancy project based on the first type of monitoring data and the target prediction model.

Optionally, the state prediction module 406 is further configured to:
determine a state calculated value based on the first type of monitoring data and the target prediction model; and
determine the state of the target water conservancy project according to the state calculated value and a state threshold.

Optionally, the model determination module 404 is further configured to:
the target coefficient index includes any one of a standard deviation, a correlation coefficient, and a certainty coefficient.

Optionally, the model determination module 404 is further configured to:
the preset prediction model set includes at least one of a gray model, a time series model, and a neural network model.

Embodiments of this description provide a water conservancy project operation trend prediction method and apparatus, wherein the water conservancy project operation trend prediction apparatus includes: acquiring to-be-processed initial monitoring data, and determining a first type of monitoring data and a second type of monitoring data according to the initial monitoring data; determining a target nonlinear fitting model from a preset nonlinear fitting model set according to the second type of monitoring data, wherein the preset nonlinear fitting model set includes at least one of a logarithmic function, an exponential function, a power function and a polynomial function; and predicting the state of a target water conservancy project based on the first type of monitoring data and according to the target nonlinear fitting model and a preset prediction model set, wherein prediction models in the preset prediction model set are trained based on the second type of monitoring data. Therefore, the new model is constructed by combining the target nonlinear fitting model with the models in the preset prediction model set, and the state of the target water conservancy project is predicted, so that the prediction accuracy is improved.

The above is a schematic solution of a water conservancy project operation trend prediction apparatus of this embodiment. It should be noted that the technical solution of the water conservancy project operation trend prediction apparatus belongs to the same concept as the technical solution of the water conservancy project operation trend prediction method described above, and the details of the technical solution of the water conservancy project operation trend prediction apparatus that are not described in detail may refer to the description of the technical solution of the water conservancy project operation trend prediction method described above.

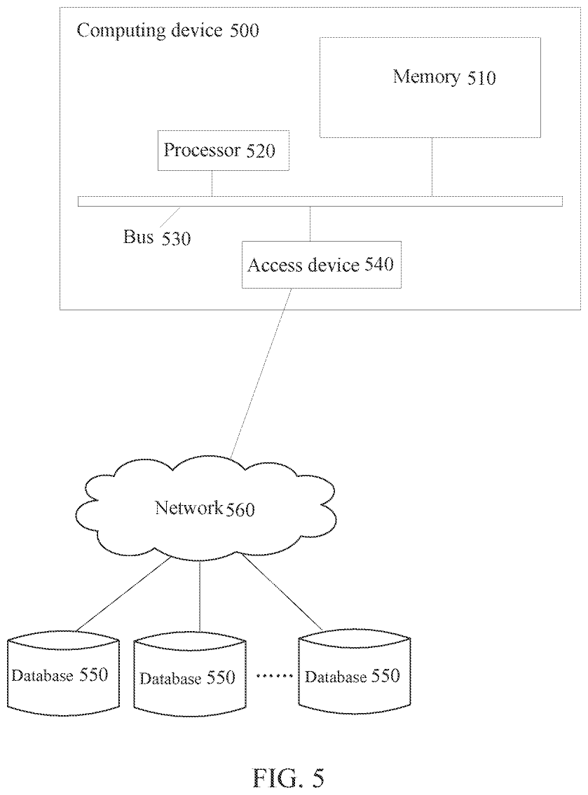

FIG. 5 shows a structural block diagram of a computing device 500 according to an embodiment of this description. Components of the computing device 500 include, but are not limited to, a memory 510 and a processor 520. The processor 520 is connected to the memory 510 via a bus 530, and a database 550 is configured to store data.

The computing device 500 also includes an access device 540 that enables the computing device 500 to communicate via one or more networks 560. Examples of these networks include public switched telephone network (PSTN), local area network (LAN), wide area network (WAN), personal area network (PAN) or a combination of communication networks such as the Internet.

The access device 540 may include one or more of any type of network interfaces (e.g., a network interface card (NIC)), wired or wireless, such as an IEEE802.11 wireless local area network (WLAN) wireless interface, a worldwide interoperability for microwave access (Wi-MAX) interface, an Ethernet interface, a universal serial bus (USB) interface, a cellular network interface, a Bluetooth interface and a near field communication (NFC) interface.

In one embodiment of this description, the components of the computing device 500, as well as other components not shown in FIG. 5 may also be connected to each other, for example, through a bus. It should be understood that the structural block diagram of the computing device shown in FIG. 5 is only for the purpose of illustration, and is not intended to limit the scope of this description. Those skilled in the art may add or replace other components as desired.

The computing device 500 may be any type of stationary or mobile computing device, including mobile computers or mobile computing devices (e.g., tablet computers, personal digital assistants, laptop computers, notebook computers, netbooks, etc.), mobile phones (e.g., smart phones), wearable computing devices (e.g., smart watches, smart glasses, etc.) or other types of mobile devices, or stationary computing devices such as desktop computers or PCs. The computing device 500 may also be a mobile or stationary server.

The processor 520 is configured to implement the steps of the data processing method when executing the following computer executable instructions.

The above is a schematic solution of a computing device of this embodiment. It should be noted that the technical solution of the computing device belongs to the same concept as the technical solution of the water conservancy project operation trend prediction method described above, and the details of the technical solution of the computing device that are not described in detail may refer to the description of the technical solution of the water conservancy project operation trend prediction method described above.

An embodiment of this description also provides a computer-readable storage medium storing computer instructions, wherein the instructions, when executed by a processor, are configured to implement the steps of the water conservancy project operation trend prediction method as described above.

The above is a schematic solution of a computer-readable storage medium of this embodiment. It should be noted that the technical solution of the storage medium belongs to the same concept as the technical solution of the water conservancy project operation trend prediction method described above, and the details of the technical solution of the storage medium that are not described in detail may refer to the description of the technical solution of the water conservancy project operation trend prediction method described above.

Specific embodiments of this description have been described above. Other embodiments are within the scope of the appended claims. In some cases, the actions or steps recited in the claims may be performed in a different order than in the embodiment and still achieve desirable results. In addition, the processes depicted in the drawings do not necessarily require the specific order shown or the sequential order to achieve the desired results. In some embodiments, multitasking and parallel processing are also possible or may be advantageous.

The computer instructions include computer program code, which may be in source code form, object code form, an executable file or some intermediate form. The computer-readable medium may include any entity or device capable of carrying the computer program code, recording medium, USB flash disk, mobile hard disk, magnetic disk, optical disk, computer memory, Read-Only Memory (ROM), Random Access Memory (RAM), electric carrier signal, telecommunication signal, software distribution medium, etc. It should be noted that the contents contained in the computer-readable medium may be appropriately added or reduced according to the requirements of legislation and patent practice in the jurisdiction. For example, in some jurisdictions, according to legislation and patent practice, the computer-readable medium does not include electric carrier signals and telecommunication signals.

It should be noted that for the sake of simple description, all the aforementioned method embodiments are expressed as a series of action combinations, but those skilled in the art should know that the embodiments of this description are not limited by the described action sequence, because some steps can be performed in other sequences or at the same time according to the embodiments of this description. Furthermore, those skilled in the art will also appreciate that the embodiments described herein are preferred embodiments, and that the acts and modules involved are not necessarily all required for the embodiments of this description.

In the above embodiments, the description of each embodiment has its own emphasis, and parts not described in detail in one embodiment may refer to in the description of other embodiments.

The preferred embodiments of this description disclosed above are intended only to help explain this description. Alternative embodiments do not describe all details in detail nor do they limit the disclosure to only the specific embodiments described. Obviously, many modifications and changes may be made according to the contents of the embodiments of this description. These embodiments are selected and described in detail in this description in order to better explain the principles and practical applications of the embodiments of this description, so that those skilled in the art can better understand and make use of this description. This description is limited only by the claims, along with their full scope and equivalents.

What is claimed is:

1. A water conservancy project operation trend prediction method, comprising:
acquiring to-be-processed initial monitoring data, periodically detecting the initial monitoring data to determine periodic data and aperiodic data, periodically decomposing the periodic data to determine periodic item data and trend item data, determining a first type of monitoring data according to the periodic item data, and determining a second type of monitoring data according to the aperiodic data and the trend item data;
determining a target nonlinear fitting model from a preset nonlinear fitting model set according to the second type of monitoring data, wherein the preset nonlinear fitting model set comprises at least one of a logarithmic function, an exponential function, a power function and a polynomial function; and
constructing a target prediction model according to a target coefficient index and through the target nonlinear fitting model and models in a preset prediction model set, and predicting a state of a target water conservancy project based on the first type of monitoring data and the target prediction model, wherein a prediction model in the preset prediction model set is trained based on the second type of monitoring data.

2. The water conservancy project operation trend prediction method according to claim 1, wherein the step of determining a target nonlinear fitting model from a preset nonlinear fitting model set according to the second type of monitoring data comprises:
determining the target nonlinear fitting model from a preset nonlinear fitting model set according to the second type of monitoring data and through a target coefficient index.

3. The water conservancy project operation trend prediction method according to claim 1, wherein the step of predicting a state of a target water conservancy project based on the first type of monitoring data and the target prediction model comprises:
determining a state calculated value based on the first type of monitoring data and the target prediction model; and
determining the state of the target water conservancy project according to the state calculated value and a state threshold.

4. The water conservancy project operation trend prediction method according to claim 1, wherein the target coefficient index comprises any one of a standard deviation, a correlation coefficient, and a certainty coefficient.

5. The water conservancy project operation trend prediction method according to claim 2, wherein the target coefficient index comprises any one of a standard deviation, a correlation coefficient, and a certainty coefficient.

6. The water conservancy project operation trend prediction method according to claim 1, wherein the preset prediction model set comprises at least one of a gray model, a time series model, and a neural network model.

7. The water conservancy project operation trend prediction method according to claim 2, wherein the preset prediction model set comprises at least one of a gray model, a time series model, and a neural network model.

8. The water conservancy project operation trend prediction method according to claim 3, wherein the preset prediction model set comprises at least one of a gray model, a time series model, and a neural network model.
